(19) United States
(12) Patent Application Publication
(10) Pub. No.: US 2014/0053416 A1
(43) Pub. Date: Feb. 27, 2014

(54) Protective Wear Cap For Flexible Line Rotary Trimmer Heads

(71) Applicant: Richard A. Proulx, Alta Loma, CA (US)

(72) Inventor: Richard A. Proulx, Alta Loma, CA (US)

(73) Assignee: PROULX MANUFACTURING, INC., Rancho Cucamonga, CA (US)

(21) Appl. No.: 13/592,264

(22) Filed: Aug. 22, 2012

(51) Int. Cl. A01D 34/416; A01D 75/00

(52) U.S. Cl. 30/347; 30/348

(57) ABSTRACT

A protective wear cap for use on a trimmer head of a flexible line rotary trimmer including a cylindrical side wall terminating at its upper end in an upper mounting wall and at its lower end in a radially projecting protective flange. A mounting aperture is centrally disposed in the mounting wall of the wear cap so that a drive shaft of a rotary trimmer can extend through the housing and through the mounting aperture into the wear cap to be engaged by a fastening member securing the wear cap to the drive shaft of the rotary trimmer and to the trimmer head. The cylindrical side wall of the wear cap defines an axial length sized to position the protective flange thereon below the lowermost surface of the trimmer head to protect the trimmer head from wear during use.

### BACKGROUND OF THE INVENTION

The present invention is directed to a protective wear cap for use in flexible line rotary trimmer heads. Flexible line rotary trimmers are commonly used for cutting vegetation such as grass and weeds, particularly along walks, fences and flower beds and along trees. These devices comprise a rotary driven head that pays out one or more lengths of monofilament line mounted within a housing. Extended end portions of each line projects from the housing through guides in the side wall of the housing. As the head rotates at high speed, the end portions of the line are caused to project outwardly from the housing by the centrifugal forces acting thereon and function as cutting blades.

The majority of trimmer heads presently in use employ two separate monofilament lines which are wrapped about a common spool mounted within the head housing. The lines project from the spool and housing through diametrically opposed guides in the side wall of the trimmer head housing. When the cutting line projected from the line breaks or becomes overly worn, fresh line must be extended from head and the old line severed and discarded. There are a variety of mechanisms for paying out the new line, each of which require the user to replace the line when the original supply has been consumed. For the casual home user, this can present a problem. Depending on the particular head, generally at least two separate lines, several feet in length, must be wrapped about the spool. If this is not done properly, the line may tangle within the head, interfering with the withdrawal of fresh line and requiring disassembly of the head and rewinding of the line. The more complicated the line feed mechanism, the more critical is the proper winding of the line within the head.

Several attempts have been made to provide a more user-friendly rotary cutting head. Such heads typically employ one or more short lengths of line which are anchored within the head in lieu of the longer lengths of line wrapped about an interior spool. These heads are frequently referred to as fixed line cutting heads. An example of such a head is found in U.S. Pat. No. 6,928,741. As fixed line heads generally present a lower profile than the spool-type heads due to the absence of a depending knob on the lowermost surface of the head or spool, fixed line heads can cut very close to the ground without having to tilt the head. Thus, fixed line heads are preferred for scalping applications as they can cut a wider swath by remaining parallel to the ground during use. However, in rough terrain scalping applications where the rapidly rotating heads are being continually pressed against the ground, the heads experience excessive wear and as a result, a relatively short life. Metal fixed line heads have been used for such applications, however such heads are typically more expensive than those heads constructed of a plastic polymer material such as glass reinforced nylon. Thus, there exists a need for flexible line rotary trimmer heads having the advantages of the currently available low profile fixed line trimmer heads for use in scalping applications on rough terrain but which are more wear resistant. It would also be highly advantageous if the feature rendering such heads more wear resistant could be utilized on existing heads for such applications, thereby obviating the need to purchase new trimmer heads for such work. The present invention obtains such results.

### SUMMARY OF THE INVENTION

Briefly, the present invention comprises a protective wear cap particularly adapted for use in low profile, fixed line heads used for scalping application in rough terrain. The wear cap of the present invention is mountable in the centrally disposed cylindrical cavity typically found in fixed line heads. The wear cap is preferably constructed of a wear resistant material and comprises a cylindrical side wall terminating at its upper end in an upper annular mounting wall circumscribing a centrally disposed mounting aperture and at its lower end in a radially projecting protective flange. When positioned in the trimmer head cavity, the mounting wall at the upper end of the wear cap is adjacent to an interior upper surface of the trimmer head with the mounting aperture in the cap axially aligned with the centrally disposed drive shaft receiving aperture in the upper end of the trimmer head whereby the drive shaft of the trimmer head can extend through the aligned apertures in the trimmer head and the wear cap and be engaged by a fastener interiorly of the wear cap, securing the mounting wall on the cap against the upper interior surface of the trimmer head. So secured, the protective flange at the lower end of the cap defines the lowermost surface of the head, thereby protecting the lower portion of the trimmer head during use.

To accommodate a variety of rotary trimmers having differently sized drive shafts, the centrally disposed mounting aperture in the cap preferably is sized to allow the extended threaded ends of the larger diameter drive shafts typically found on rotary trimmers to extend therethrough. The wear cap then can be secured in place on trimmer heads used with smaller diameter drive shafts using a reducer bushing with an appropriate fastener. The reducing bushing preferably defines a centrally disposed aperture therein having a transverse diameter generally sized for the particular rotary trimmer drive shaft on which the wear cap will be mounted, which can be substantially smaller than the transverse dimension of the mounting aperture in the wear cap. The reducing bushing can be provided with a raised annular alignment ridge outwardly spaced from the mounting aperture in the bushing and sized so as to project into the mounting aperture in the wear cap and abut the annular side wall of the mounting aperture so as to axially align the mounting aperture in the reducer bushing with the central axes of the wear cap and the rotary trimmer drive shaft. Alternatively, the outer diameter of the reduction bushing, or at least a portion thereof, can be sized so as to abut the interior of the side wall of the wear cap adjacent to the mounting wall to align the mounting aperture in the bushing with the larger aperture in the mounting wall of the cap.

The cylindrical side wall of the wear cap preferably defines one or more apertures therein to allow the inner end portions of the lengths of nylon cutting line carried by the trimmer head to extend therethrough to facilitate installation and removal of the lengths of cutting line and is axially sized so as to position the protective flange at the lower end of the cap below the lower most surface of the trimmer head and thereby prevent wear on the underside of the trimmer head during use. So configured, the wear cap of the present invention can be provided as an original feature on trimmer heads or mounted on existing trimmer heads having centrally disposed cavities therein as an aftermarket feature, thereby providing wear protection for a wide variety of trimmer heads.

### BRIEF DESCRIPTION OF THE DRAWINGS

FIG. 1 is a perspective view of the protective wear cap of the present invention.

FIG. 2 is a sectional view taken along the line 2-2 of FIG. 1.

FIG. 3 is a sectional side view of a low profile fixed line head with the protective wear cap of the present invention mounted therein.

FIG. 4 is a sectional side view of a modified embodiment of the present invention.

FIG. 5 is a sectional side view of the present invention employing an aperture reduction bushing.

FIG. 6 is a sectional side view of the present invention employing an alternative embodiment of the aperture reduction bushing.

### DETAILED DESCRIPTION OF THE PREFERRED EMBODIMENTS

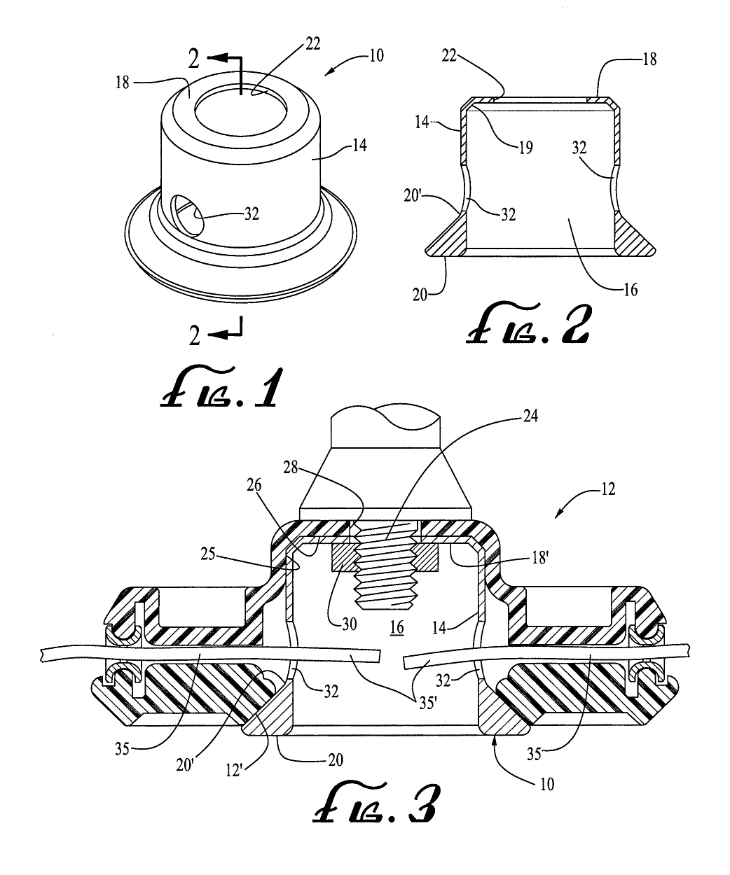

Referring now in detail to the drawings, the protective wear cap 10 of the present invention is illustrated in FIGS. 1 and 2 and shown mounted in a low profile fixed line rotary trimmer head 12 in FIG. 3. The protective wear cap 10 is preferably of single piece construction and formed of a lightweight durable material such as anodized aluminum, although other wear resistant durable materials could be used. By way of example, the wear cap could be formed of cold rolled steel, case hardened and black oxide added for further hardening and appearance. The cap comprises a cylindrical side wall 14 circumscribing an interior area 16. The cylindrical side wall 14 terminates at its upper end in an annular mounting wall 18 and at its lower end in an annular radially projecting protective flange 20. The mounting wall 18 on the wear cap 10 circumscribes a mounting aperture 22 adapted to receive therethrough the extended threaded end of a rotary trimmer drive shaft 24 (see FIG. 3).

In use, the protective wear cap 10 is positioned in a centrally disposed cavity 25 in the trimmer head of the type commonly found in low profile fixed line trimmer heads, like head 12. So positioned, the mounting wall 18 at the upper end of the wear cap is adjacent to the upper interior surface 26 of the trimmer head 12 and the mounting aperture 22 in wall 18 is axially aligned with the drive shaft receiving aperture 28 in the upper end of the trimmer head. As illustrated in FIG. 3, the depending drive shaft 24 on the rotary trimmer extends through the aligned mounting apertures 28 and 22 and is threadably engaged by a suitable fastening member 30. Upon tightening the fastener member 30 against the upper interior surface 18′ of the mounting wall 18, the wear cap 10 is secured against the interior trimmer head surface 26, securing the wear cap 10 to the trimmer head 12 and the trimmer head to the drive shaft 24 of a rotary trimmer. The wear cap is sized relative to the trimmer head(s) with which it is to be used so as to fit within trimmer head cavity 25 and the cylindrical side wall 14 is provided with sufficient length such that upon the wear cap being secured to the trimmer head surface 26, the protective flange 20 defines the lower most surface of the trimmer head.

The cylindrical side wall 14 of the wear cap also preferably defines at least one and more typically a plurality of openings 32 in the side wall thereof (two opposed openings being most common and shown in the drawings) to accommodate the inner end portion(s) 35′ of the length(s) of flexible nylon cutting line 35 carried by the trimmer head 12. The side openings 32 in the wear cap 10 render the cap compatible with fixed line heads, such as that disclosed in U.S. Pat. No. 6,519,857, the teachings of which are incorporated herein by reference as though fully set forth below. In the patented trimmer head, the inner ends of the cutting line are inserted through line guides in the side of the trimmer head and aligned interior channels that direct the inner end portions of the line to a visible and accessible open central portion of the head, allowing the user to visually determine when the line has been inserted a sufficient distance into the head to effect proper loading of the line and, when the line becomes overly worn or broken, the exposed end portions of the line can be readily grasped by the user pulled inwardly through and from the head for replacement as is described in more detail in the above cited patent. The line gripping cam mechanisms on the patented trimmer head hold the line in place during use and prevent the lengths of cutting line from being pulled outwardly through the line guides for removal. With the wear cap 10 secured in place in cavity 25 as above described, the inner end portions of the cutting line project through the opposed openings 32 in the side wall 14 of the protective wear cap and into the interior area 16 thereof where the end portions of the line are visible and readily accessible.

The wear cap of the present invention may be particularly configured for a particular trimmer head configuration, e.g. trimmer head 12, such that the outer contour of the wear cap 10 mates with the interior surfaces of the upper portion 12′ of the trimmer head, as is shown in FIG. 3. With the configuration of trimmer head 12 illustrated in FIG. 3, the upper mounting wall 18 defines a chamfered surface 19 transitioning the vertical cylindrical side wall 14 of the wear cap into the horizontally disposed (as illustrated in the drawings) mounting wall 18 at the upper end of the cap. Similarly, the protective annular flange 20 can be radiused along its upper outer surface 20′ to follow and mate with the interior contour of the trimmer head 12 as is also illustrated in FIG. 3. Also, the wear cap can be specifically designed for use with rotary trimmers having a given diameter of drive shafts by sizing the mounting aperture 22 in the wear cap to fit about the drive shaft 24 with minimal clearance of about 0.25 mm.-0.40 mm. to center the wear cap on the drive shaft.

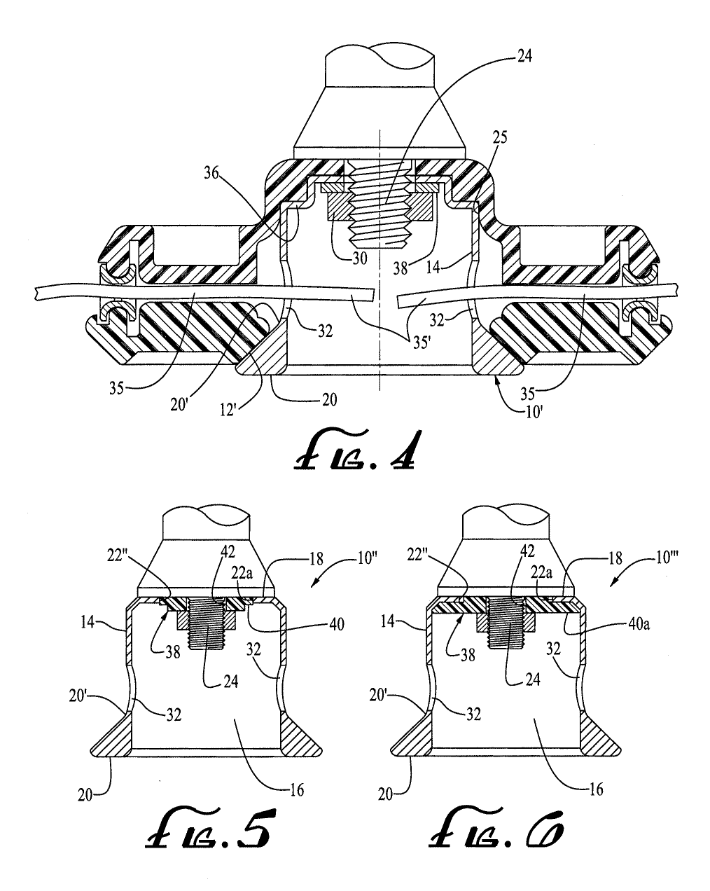

To accommodate other trimmer head designs, the wear cap can be provided with other modifications. For example, a step or offset 36 can be provided adjacent the upper end thereof as illustrated in FIG. 4. The inwardly disposed offset 36 illustrated in FIG. 4 allows the protective wear cap 10′ to fit within the interior cavity of a popular fixed line head design that includes an inwardly projecting annular horizontal surface (not shown) that is accommodated by the offset. Note that a washer 38 can be employed between the nut or other fastening member 30 and the upper interior surface of the cap 10′ as shown in FIG. 4. If desired, a washer could be disposed between the fastening member and the upper interior surface 26 in other embodiments of the present invention, including the embodiment of FIG. 3. Other such modifications also could be made to the configuration of the wear cap either to better fit within the central cavity of a particular trimmer head or to increase the compatibility of the wear cap with differently configured head designs.

As noted earlier herein, different rotary trimmers have different sized drive shafts. To accommodate such drive shafts, the mounting aperture 22 in the mounting wall 18 of wear cap 10 can be enlarged to accommodate the larger diameter drive shafts typically used on these rotary trimmers. In one embodiment of the present invention, the wear cap 10″ defines a mounting aperture 22″ having a diameter of about 25 mm. As a more typical trimmer head drive shaft may define a diameter of about 7 mm.-12 mm., an aperture reduction bushing 38 is preferably provided between the threaded fastening member 30″ and the interior upper surface 18″ of the wear cap 10″ (see FIG. 5). Aperture reduction bushing 38 is preferably formed of a plastic material and provided with a raised arcuate or annular portion(s) 40 outwardly spaced from the mounting aperture 42 in the bushing and sized so as to project into the enlarged mounting aperture 22″ in the wear cap 10″ and abut the annular side wall 22a of the mounting aperture 22″ so as to axially align the mounting aperture 22″ in the aperture reduction bushing 38 with the central axes of the wear cap and the rotary trimmer drive shaft. The raised annular portion 40 in the reducing bushing could be in the form of an annular ridge, curvilinear segments of an annular ridge or other suitable configuration. As shown in FIG. 4, the raised annular portion 40 defines an annular disc, sized such that the perimeter thereof abuts the annular side wall 22a of the mounting aperture. In such an embodiment, the diameter of the mounting aperture 42 in the bushing will vary depending on the diameter of the drive shaft on which the wear cap is to be mounted. A typical mounting aperture diameter would be approximately 10 mm. By providing the enlarged mounting aperture in the wear cap, such as aperture 22″, in combination with a plurality of aperture reduction bushings having slightly different diameter mounting apertures therein, the same wear cap can be employed with a variety of differently-sized trimmer drive shafts, significantly increasing the versatility of the wear cap for aftermarket applications.

In another variation of the present invention, the outer diameter of the aperture reduction bushing can be sized to mate with the inner diameter of the cylindrical side wall of the wear cap at least opposed portions of the outer surface of the bushing could be configured to mate with the interior of the side wall of the wear cap to effect the desired centering of the reduction bushing relative to the wear cap. Such a feature could be employed in lieu of the centering ridge 40a.

Thus, the wear cap of the present invention can be specifically configured for particular head configurations or contain modifications such as offset 32 to increase the compatibility of the wear cap with the larger number of trimmer heads. In that regard, it should be noted that the inclusion of some modifications such as the chamfered surface 18′ and the radiusing of the upper outer surfaces 20′ of the annular protective flange 20 described with respect to wear cap 10 may not be necessary from a functionality standpoint but are provided a more finished appearance by forming a mating abutment with the interior of a particular trimmer head for which the wear cap is specifically designed.

Also, while the above exemplary embodiments of the present invention have been described in connection with low profile fixed line heads as such heads are preferred for scalping applications, the wear caps of the present invention could be employed on manual feed spool-type trimmer heads having the necessary central cavity therein to accommodate the wear cap. For such applications, the wear cap would likely be somewhat larger in size, particularly in the axial direction to properly position the protective flange at the bottom of the cap below the lowermost surface of the head or spool.

Although the present invention has been described by way of exemplary embodiments, it should be understood that various additional changes and modifications may be made by those skilled in the art in carrying out the present invention without departing from the spirit and the scope thereof, which is defined by the appended claims.

What is claimed is:

1. A protective wear cap securable by a fastening member in a trimmer head of a flexible line rotary trimmer in which the trimmer head includes a centrally disposed generally cylindrical cavity therein communicable with a drive shaft of a rotary trimmer, said wear cap comprising a cylindrical side wall terminating at its upper end in an upper mounting wall and at its lower end in a radially projecting protective flange, a mounting aperture centrally disposed in said mounting wall whereby a drive shaft of a rotary trimmer extending into a trimmer head and through said mounting aperture can be engaged by a fastening member within said wear cap so as to secure said wear cap to the drive shaft and to the trimmer head and wherein said cylindrical side wall of said wear cap defines an axial length sufficient to position said protective flange thereon below the trimmer head so as to define a lowermost trimmer head surface and thereby protect the trimmer head from wear during use.

2. The protective wear cap of claim 1 wherein said cylindrical wall of said wear cap defines at least one aperture therein between said upper and lower ends thereof for the passage of line therethrough.

3. The protective wear cap of claim 1 including an aperture reduction bushing adapted to be disposed within said wear cap between and adjacent to said mounting wall and a fastening member, said bushing defining a mounting aperture therein having a diameter substantially smaller than the diameter of said mounting aperture in said mounting wall and including an upstanding portion thereon configured to project into said mounting aperture in said mounting wall adjacent portions of said mounting wall extending about the perimeter of said mounting aperture therein thereby axially aligning said mounting aperture in said aperture reduction bushing with said mounting aperture in said mounting wall.

4. The protective wear cap of claim 3 wherein said mounting aperture in said mounting wall defines a diameter of about 25 mm. and said mounting aperture in said aperture reduction bushing defines a diameter within the range of about 7 mm.-12 mm.

5. The wear cap of claim 3 wherein said cylindrical wall of said wear cap defines at least one aperture therein between said upper and lower ends thereof for the passage of line therethrough.

6. The wear cap of claim 3 wherein said upstanding portion of said aperture reduction bushing is of an annular configuration.

7. The protective wear cap of claim 1 including an aperture reduction bushing adapted to be disposed within said wear cap between and adjacent to said mounting wall and a fastening member, said bushing defining a mounting aperture therein having a diameter substantially smaller than the diameter of said mounting aperture in said mounting wall and wherein at least opposing portions of an outer surface of said bushing are configured to mate with portions of the interior surface of said cylindrical wall of said wear cap upon said bushing being disposed adjacent to said mounting wall, thereby axially aligning said mounting aperture in said aperture reduction bushing with the mounting aperture in said mounting wall.

8. The protective wear cap of claim 7 wherein said mounting aperture in said mounting wall defines a diameter of about 25 mm. and said mounting aperture in said aperture reduction bushing defines a diameter within the range of about 7 mm.-12 mm.

9. The wear cap of claim 7 wherein said cylindrical wall of said wear cap defines at least one aperture therein between said upper and lower ends thereof for the passage of line therethrough.

10. The wear cap of claim 8 wherein said cylindrical wall of said wear cap defines at least one aperture therein between said upper and lower ends thereof for the passage of line therethrough.

11. A wear resistant trimmer head for a flexible line rotary trimmer, said head comprising: a housing defining a perimeter wall portion having at least one opening therein; at least one removable length of cutting line carried by the head and projecting therefrom through said opening; a centrally disposed aperture in an upper portion of said head for receiving therethrough a drive shaft of a rotary trimmer; a centrally disposed generally cylindrical cavity disposed in said housing below and in communication with said centrally disposed aperture; a wear cap disposed in said cavity, said wear cap comprising a cylindrical wall terminating at its upper end in an annular mounting wall and at its lower end in a radially projecting protective flange and a mounting aperture centrally disposed in said mounting wall; and a fastening member engaging a drive shaft of a rotary trimmer within said wear cap, securing said wear cap to the drive shaft and to said trimmer head such that said protective flange on said wear cap defines a lowermost surface of said trimmer head, thereby protecting the trimmer head from wear during use.

12. The wear cap of claim 11 wherein said cylindrical wall of said wear cap defines at least one aperture therein between said upper and lower ends thereof for the passage of line therethrough.

13. The trimmer head of claim 11 including an aperture reduction bushing disposed in said wear cap between and adjacent to said mounting wall and said fastening member, said bushing defining a mounting aperture therein having a diameter substantially smaller than the diameter of said mounting aperture in said mounting wall and including an upstanding portion thereon projecting into said mounting aperture in said mounting wall adjacent portions of said wall extending about the perimeter of said mounting aperture therein thereby axially aligning said mounting aperture in said aperture reduction bushing with the mounting aperture in said mounting wall.

14. The trimmer head of claim 13 wherein said cylindrical wall of said wear cap defines at least one aperture therein between said upper and lower ends thereof for the passage of line therethrough.

15. The trimmer head of claim 13 wherein said mounting aperture in said mounting wall defines a diameter of about 25 mm. and said mounting aperture in said aperture reduction bushing defines a diameter within the range of about 7 mm.-12 mm.

16. The trimmer head of claim 11 including an aperture reduction bushing disposed in said wear cap between and adjacent to said mounting wall and said fastening member, said bushing defining a mounting aperture therein having a diameter substantially smaller than the diameter of said mounting aperture in said mounting wall and wherein at least opposing portions of an outer surface of said bushing mate with portions of the interior surface of said cylindrical wall of said wear cap adjacent to said mounting wall thereby axially aligning the mounting aperture in said aperture reduction bushing with the mounting aperture in said mounting wall.

17. The trimmer head of claim 16 wherein said mounting aperture in said mounting wall defines a diameter of about 25 mm. and said mounting aperture in said aperture reduction bushing defines a diameter within the range of about 7 mm.-12 mm.
